(19) United States
(12) Patent Application Publication
(10) Pub. No.: US 2024/0330648 A1
(43) Pub. Date: Oct. 3, 2024

(54) KNOWLEDGE DISTILLATION METHOD FOR COMPRESSING TRANSFORMER NEURAL NETWORK AND APPARATUS THEREOF

(71) Applicant: Gwangju Institute of Science and Technology, Gwangju (KR)

(72) Inventors: Hee Jun JUNG, Gwangju (KR); Kang Il KIM, Gwangju (KR); Do Yeon KIM, Gwangju (KR)

(73) Assignee: Gwangju Institute of Science and Technology, Gwangju (KR)

(21) Appl. No.: 18/596,994

(22) Filed: Mar. 6, 2024

(30) Foreign Application Priority Data
Mar. 30, 2023 (KR) 10-2023-0042179

(51) Int. Cl. G06N 3/042; G06N 3/082; G06N 3/096

(52) U.S. Cl. CPC G06N 3/042; G06N 3/082; G06N 3/096

(57) ABSTRACT

A method for training a student network including at least one or more of a transformer neural network by using knowledge distillation in a teacher network including at least one or more of the transformer neural network is disclosed. The method includes: pre-training the teacher network using a training data and fine tuning the trained teacher network; copying a weight parameter of a bottom layer of the teacher network to the student network; and performing the knowledge distillation to the student network through the fine-tuned teacher network. The performing the knowledge distillation includes: extracting a feature structure from the result value of a layer of the fine-tuned teacher network; extracting a feature structure from the result value of a layer of the student network; and adjusting the feature structure of the extracted student network based on the feature structure of the extracted teacher network.

### CROSS REFERENCE TO RELATED APPLICATION

The present application claims the priority to Korean Patent Application No. 10-2023-0042179, filed on Mar. 30, 2023, the entire contents of which is incorporated herein by reference for all purposes.

### STATEMENT REGARDING PRIOR DISCLOSURES BY THE INVENTOR OR A JOINT INVENTOR

Prior disclosure related to the present application was made by inventors of the present application in journal paper entitled “Feature structure distillation with Centered Kernel Alignment in BERT transferring” on Apr. 1, 2022. A copy of the journal paper is provided on a concurrently filed Information Disclosure Statement.

### BACKGROUND

### Field

The embodiment disclosure relates to a knowledge distillation method for compressing a transformer-based neural network and an apparatus for executing the same, and to a method for transferring knowledge from a teacher network to a student network.

### Description of the Related Art

As Bidirectional Encoder Representations from Transformers (BERT) appeared in the field of artificial intelligence, a large-scale model using the BERT began to appear in the field of natural language processing. The BERT is a transformer-based model that enables pre-training and fine tuning of the large-scale model just like computer vision even in the natural language processing, and provides excellent performance on a variety of problems.

However, the BERT had a problem in that a capacity of the model is very large and the BERT-base uses about 110 million parameters, so that a very large amount of memory is required to use the BERT.

In order to solve this problem, various studies have recently been attempted to make the model compress while maintaining the performance of the BERT. As one of them, a knowledge distillation (KD) method trains a network by transferring generalization ability of a teacher network, which can process a large amount of data, to a student network smaller than the teacher network, thereby achieving performance equivalent to that of the teacher network.

The technologies already published in relation to this knowledge distillation method are as follows.

First, the prior art 1 is directed to a method for understanding longitudinal spoken language using a text-based pre-training model, and utilizes a loss function in which a SLU (Spoken Language Understanding) model in the top layer and a hidden layer in the BERT top layer are equal to each other. Specifically, the prior art 1 uses a cross-entropy loss between the student's softmax function and true level.

The prior art 2 uses a temperature value that adjusts the softmax functions of the teacher network and the student network for knowledge distillation. In addition, the prior art 2 proceeds with knowledge distillation by narrowing a distance between the two result values in the nth layer of each network through an evaluation value based on Euclidean Distance.

In all of these prior arts, the student network trains knowledge distillation only from the result values of the final output of the teacher network. In particular, the prior art 2 uses the result value of the layer, but is limited to simply narrowing the distance.

### DOCUMENTS OF RELATED ART

[Prior Art 1]
Korean Patent Registration Publication No. 10-2368064 B1
[Prior Art 2]
Korean Patent Laid-Open Publication No. 10-2022-0069225 A

### SUMMARY

According to an embodiment disclosure, the present invention relates to a knowledge distillation method and an apparatus for compressing a transformer neural network that allows a model with a smaller capacity to operate at the same or higher level of performance than that of a model with a larger capacity, by extracting a feature structure between words, sentences, and memories, and executing knowledge distillation based on the extracted feature structure.

According to an embodiment disclosure, a method for training a student network including at least one or more of a transformer neural network by using knowledge distillation in a teacher network including at least one or more of the transformer neural network comprises the processes of: pre-training the teacher network using a training data and fine tuning the trained teacher network; copying a weight parameter of a bottom layer of the teacher network to the student network; and performing the knowledge distillation to the student network through the fine-tuned teacher network, wherein the process of performing the knowledge distillation includes the steps of: extracting a feature structure from the result value of a layer of the fine-tuned teacher network; extracting a feature structure from the result value of a layer of the student network; and adjusting the feature structure of the extracted student network based on the feature structure of the extracted teacher network.

The process of performing the knowledge distillation may be characterized by expressing the feature structure based on a Centered Kernel Alignment (CKA) matrix.

The process of performing the knowledge distillation may be characterized by dividing the result value of the layer into hidden states by word units within a sentence, and adjusting the feature structure of the teacher network and the feature structure of the student network based on the result of comparing the hidden states divided by the word units.

The process of performing the knowledge distillation may be characterized by dividing the hidden states of the sentence existing in a mini-batch, and adjusting the feature structure of the teacher network and the feature structure of the student network based on the result of comparing the hidden states of the sentence.

The process of performing the knowledge distillation may be characterized by clustering the hidden states of each sentence existing in the mini-batch of the teacher network, defining a representative value (centeroid) representing the clustered hidden states, and adjusting the feature structure of the memory that operates the student network, with the feature structure of the memory that operates the teacher network, based on the defined representative value.

The process of performing the knowledge distillation may be characterized by adjusting the feature structure of the teacher network and the feature structure of the student network based on the result of comparing the hidden states of each sentence and the result of comparing the feature structure of the memory.

According to another embodiment disclosure, an apparatus for training a student network including at least one or more of a transformer neural network by using knowledge distillation in a teacher network including at least one or more of the transformer neural network comprises: a storage unit for storing a program that performs the knowledge distillation; and a control unit including at least one or more processor, wherein the control unit pre-trains the teacher network using training data and fine-tunes the trained teacher network, copies a weight parameter of a bottom layer of the teacher network to the student network, extracts a feature structure from the result value of a layer of the fine-tuned teacher network, extracts a feature structure from the result value of a layer of the student network, adjusts the feature structure of the extracted student network based on the feature structure of the extracted teacher network, and performs the knowledge distillation on the trained student network through the trained teacher network by the adjustment of the feature structure.

The control unit may be characterized by expressing the feature structure based on a Centered Kernel Alignment (CKA) matrix.

The control unit may divide the result value of the layer into hidden states by word units within a sentence, and adjust the feature structure of the teacher network and the feature structure of the student network based on the result of comparing the hidden states divided by the word units.

The control unit may divide the hidden states of the sentence existing in a mini-batch, and adjusting the feature structure of the teacher network and the feature structure of the student network based on the result of comparing the hidden states of the sentence.

The control unit may cluster the hidden states of each sentence existing in the mini-batch of the teacher network, define a representative value (centeroid) representing the clustered hidden states, and adjusting the feature structure of the memory that operates the student network, with the feature structure of the memory that operates the teacher network, based on the defined representative value.

The control unit may adjust the feature structure of the teacher network and the feature structure of the student network based on the result of comparing the hidden states of each sentence and the result of comparing the feature structure of the memory.

According to an embodiment disclosure, a knowledge distillation method and an apparatus for compressing a transformer neural network allow a student network with a smaller capacity to operate at the same or higher level of performance than that of a teacher network with a larger capacity.

In addition, according to an embodiment disclosure, since a knowledge distillation method and an apparatus for compressing a transformer neural network makes the student network to operate even in a portable user terminal with a small memory capacity, they are also effective in reducing delay time as well train and inference time.

### BRIEF DESCRIPTION OF THE DRAWINGS

FIG. 1 is a diagram schematically explaining an embodiment disclosure.

FIG. 2 is a control block diagram of a knowledge distillation apparatus according to an embodiment disclosure.

FIG. 3 is a flow chart explaining a specific method for performing knowledge distillation.

FIG. 4 is a flow chart specifically explaining a process of performing knowledge distillation.

FIG. 5 is a diagram explaining a method of adjusting a local intra feature structure.

FIG. 6 is a diagram explaining a method of adjusting a local inter feature structure.

FIGS. 7A and 7B are a diagram explaining a method of adjusting a global inter feature structure.

FIGS. 8 and 9 are tables for comparing performance of a knowledge distillation method according to an embodiment disclosure.

FIGS. 10A and 10B are a diagram graphically representing the numerical values mentioned in FIGS. 8 and 9.

FIG. 11 is a diagram illustrating a CKA heat map, and FIG. 12 is a table quantifying the same.

FIG. 13 is another diagram comparing each knowledge distillation method.

### DETAILED DESCRIPTION

The same reference numerals refer to the same constitutive elements throughout the specification. The present specification does not describe all elements of the embodiments, and general contents or overlapped contents between the embodiments in the technical field to which the present invention pertains is omitted. The terms of ‘unit’, ‘module’, ‘member’, ‘block’ used in the specification may be implemented as a software or a hardware, and depending on the embodiments, a plurality of ‘unit’, ‘module’, ‘member’, ‘block’ may be implemented as a single constitutive element, or may also include multiple constitutive elements for one ‘unit’, ‘module’, ‘member’, or ‘block’.

Throughout the specification, in case a certain part is said to be “connected” to another part, this includes not only direct connection but also indirect connection, and the indirect connection includes connection through a wireless communication network.

Further, in case a certain part is said to “include” a certain constitutive element, this means that it may further include other constitutive elements, rather than excluding the other constitutive elements, unless specifically stated to the contrary.

Throughout the specification, in case a certain member is said to be located “on” another member, this includes not only a case where the member is in contact with another member, but also a case where another member exists between the two members.

The terms such as first and second are used to distinguish one constitutive element from another constitutive element, and the constitutive elements are not limited by the above-mentioned terms.

A singular expression includes a plural expression unless there is a clear exception from the context.

The identification symbols for each step are used for convenience of explanation. They do not explain the order of each step, and each step may be performed differently from a specified order unless the context clearly states the specific order.

Hereinafter, the operating principle and embodiments of the present invention will be described with reference to the attached drawings.

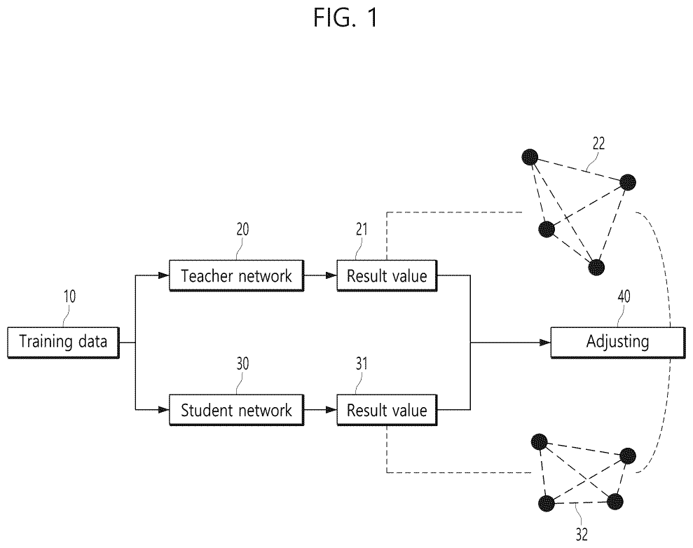

FIG. 1 is a diagram schematically explaining an embodiment disclosure.

Referring to FIG. 1, an embodiment of the present invention uses knowledge distillation (KD) to train a deep neural network (DNN). The knowledge distillation refers to a means of training a student network 30 by transmitting a relatively larger network, i.e., a generalization ability of a teacher network 20, into a relatively smaller network, i.e., the student network 30, in terms of a volume and capacity of data processing and training data. The teacher network 20 provides hard-target information and soft-target information to the student network 30 so that the student network 30 is trained to generalize similarly to the teacher network 20.

In the present invention, a neural network trained using the knowledge distillation method is a transformer-based neural network, and may be Bidirectional Encoder Representations from Transformers (BERT) according to an embodiment. In this case, the transformer follows an encoder-decoder structure of seq2seq, and may be a model implemented only with Attention without using RNN.

Before carrying out the knowledge distillation, both the teacher network 20 and the student network 30 undergo pre-training using a training data 10. The teacher network 20 and the student network 30 have result values 21 and 31 that fill each layer with a data through the pre-training. The knowledge distillation method according to the embodiment disclosure is performed so that the student network 30 becomes identical or similar to the teacher network 20 through the processes of clustering the result values that can be extracted for each layer (or memory) of the teacher network 20 and the student network 30 into feature structures 22 and 32, and adjusting 40 the feature structure 32 of the student network 30 with the feature structure 22 of the teacher network 20.

Herein, the feature structure is defined as a set of relations, and is expressed using a Centered Kernel Alignment (CKA) metric. In addition, the disclosed knowledge distillation method is clustered into a local intra feature structure, a local inter feature structure, and a global inter feature structure, and the knowledge distillation can be performed at each level of the feature structures. Specifically, the local intra feature structure is defined as relationships between word tokens, the local inter feature structure is defined as relationships between sentences representations, and the global inter feature structure is defined as relationships between sentence representations and memory.

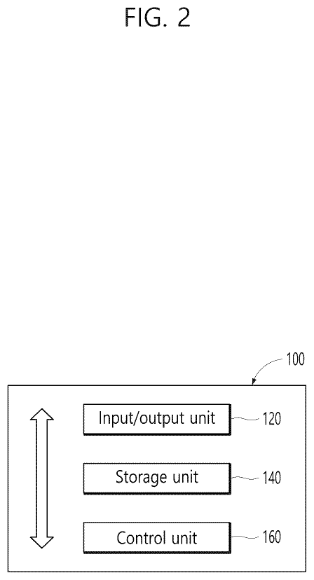

FIG. 2 is a control block diagram of a knowledge distillation apparatus according to an embodiment disclosure.

Referring to FIG. 2, the knowledge distillation apparatus 100 may comprise an input/output unit 120, a storage unit 140, and a control unit 160.

The input/output unit 120 according to an embodiment may include an input device for receiving input from a user and an output device for displaying information such as a task performance result or a status of the knowledge distillation apparatus 100.

The input device of the input/output unit 120 may include hardware devices such as various buttons or switches, a pedal, a keyboard, a mouse, a track-ball, various levers, a handle, or a stick, etc. to receive input instructions of the user.

The output device of the input/output unit 120 may be provided with hardware devices such as a display for displaying trained and output images and a speaker for outputting sound. The display may include a digital light processing (DLP) panel, a plasma display panel, a liquid crystal display (LCD) Panel, an electro luminescence (EL) panel, an electrophoretic display (EPD) panel, an electrochromic display (ECD) panel, a light emitting diode (LED) panel, or an organic light emitting diode (OLED) panel.

Instead of the input device, the input/output unit 120 may include a graphical user interface (GUI), that is, a software device, such as a touch pad for instructing the user's input. The touch pad may be implemented as a touch screen panel (TSP) so as to form a mutual layer structure with the display.

The storage unit 140 may store data for training the student network 30 by performing the knowledge distillation. For example, the storage unit 140 may store a training data 10 for training a neural network (the teacher network 20, the student network 30), and may store result values of the teacher network 20 which required for the knowledge distillation to train the student network 30. In addition, the storage unit 140 may store various data or programs necessary for the knowledge distillation to train the student network 30.

The storage unit 140 may be implemented as at least one of a non-volatile memory device such as a read only memory (ROM), a programmable ROM (PROM), an erasable programmable ROM (EPROM), an electrically erasable programmable ROM (EEPROM), and a flash memory, or a volatile memory device such as a random access memory (RAM), or a storage medium such as a hard disk drive (HDD) and a CD-ROM, but is not limited thereto.

The control unit 160 controls an overall operation of the knowledge distillation apparatus 100, and may be implemented as a memory (not shown) that stores data for an algorithm for controlling an operation of constitutive elements within the knowledge distillation apparatus 100 or a program that reproduces the algorithm, and a processor (not shown) that performs the above-described operation using the data stored in the memory. In this case, the memory and the processor may be implemented as a separate chip, respectively. Alternatively, the memory and the processor may be implemented as a single chip.

In particular, the control unit 160 may execute a program stored in the storage unit 140 or read the data to perform the knowledge distillation for training the student network 30. A specific method by which the control unit 160 performs the knowledge distillation for training the student network 30 will be described in detail with reference to other drawings below.

The storage unit 140 may be a memory implemented as a separate chip from the processor previously described in relation to the control unit 160, or may be implemented as a single chip with the processor.

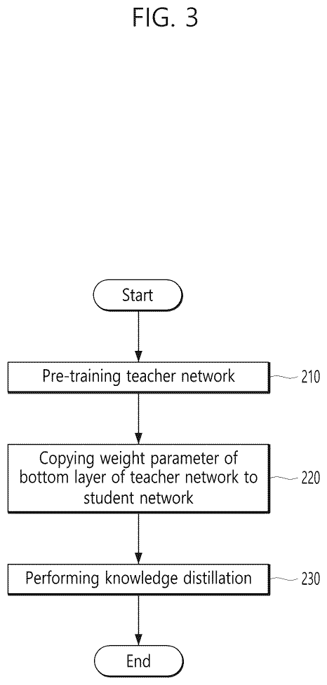

FIG. 3 is a flow chart explaining a specific method for performing knowledge distillation.

Referring to FIG. 3, the control unit 160 pre-trains the teacher network 20 (210).

There may be various methods for pre-training the teacher network 20. The pre-training process of the teacher network 20 may include a pre-processing process in which each sequence can be input in order for a transformer neural network to perform natural language training, wherein each word in the input sequence is converted into a dense vector form through an embedding process. The embedding is a process of mapping the word into a high-dimensional vector space, which allows a model to calculate similarity between the words.

An encoder included in the teacher network 20 processes the input sequence, and a plurality of attention layers (hereinafter referred to as layers) extract information necessary for word generation from the input sequence. In this process, the teacher network 20 can perform fine tuning in a direction of minimizing a loss function.

A weight parameter of a bottom layer of the pre-trained teacher network (20) is copied to the student network 30 (220).

Herein, the bottom layer of the teacher network 20 may be a weight parameter included in the 1st to 6th layers. However, the bottom layer does not necessarily correspond to the 1st to 6th layers, and may have various modifications. Once the fine tuning of the teacher network 20 is completed, the control unit 160 proceeds with the knowledge distillation (230).

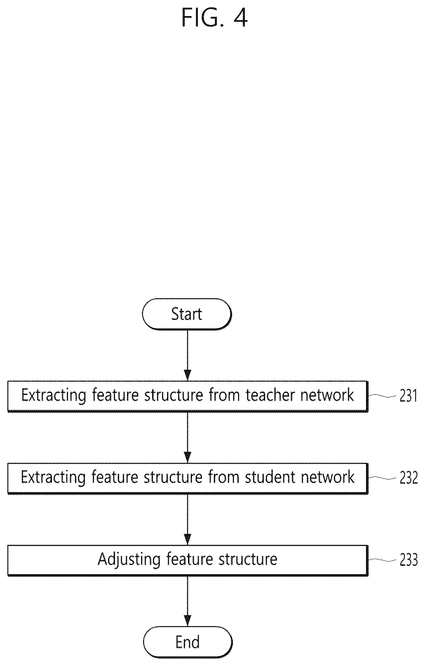

FIG. 4 is a flow chart specifically explaining a process of performing knowledge distillation.

Referring to FIG. 4, the control unit 160 extracts a feature structure from the result value of the layer of the pre-trained teacher network (231), and extracts a feature structure from the result value of the layer of the student network from which the weight parameter of the bottom layer of the teacher network is copied (232).

As described above, the feature structure is expressed based on the CKA matrix. Herein, the CKA matrix is a matrix that measures whether two embedding matrices used in machine learning share a similar space. When the two embedding matrices are X and Y, the CKA matrix first calculates an internal value of the two matrices followed by calculating each internal value of X and Y to normalize these values. The CKA matrix measures and displays a similarity between the two embedding matrices by calculating a cosine similarity between the two normalized internal values. The CKA matrix expresses a degree to which the two embedding matrices share a similar space as a value between 0 and 1. It is meant that the closer the value is to 1, the more space that the two matrices share, and the closer the value is to 0, the two matrices are located in different spaces from each other.

In this way, the feature structure can make it robust to constraints related to the embedding matrixes and reduce ambiguity that occurs in the knowledge distillation process by measuring and expressing a simple Euclidean distance or a similarity between the two embedding matrices based on the CKA matrix instead of the cosine similarity.

The control unit 160 adjusts a feature structure extracted from the student network 30 to a feature structure of the teacher network 20 (233).

The control unit 160 performs the knowledge distillation by comparing a difference in values between the CKA matrices extracted from the teacher network 20 and the student network 30, respectively, and adjusting the feature structure of the student network 30 to the feature structure of the teacher network 20 based on the comparison result.

Meanwhile, the disclosed knowledge distillation method performs the knowledge distillation by clustering the feature structure into a local intra feature structure indicating relationships between words, a local inter feature structure indicating relationships between sentences, and a global inter feature structure indicating relationships between memories of each network or between the memories and the sentences. A detailed description therefor will be provided later with reference to the drawings.

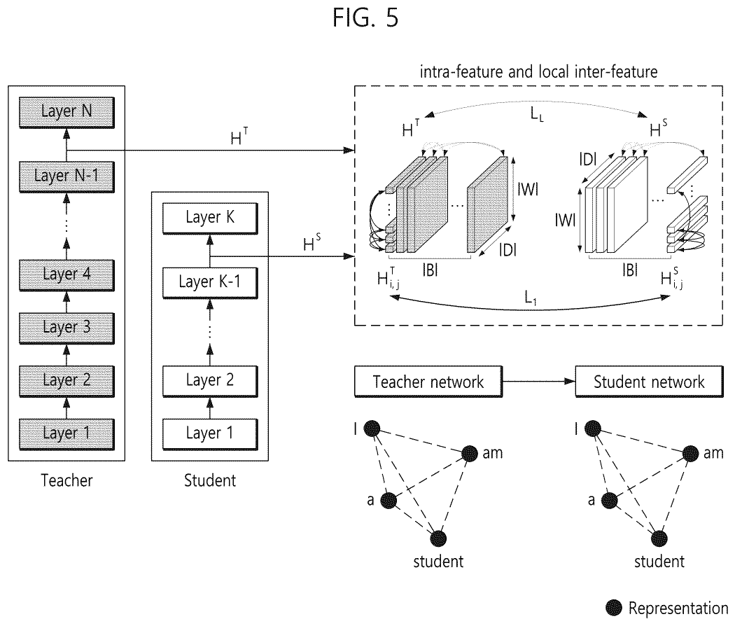

FIG. 5 is a diagram explaining a method of adjusting a local intra feature structure.

Referring to FIG. 5, the control unit 160 divides a hidden state by a word (I, am, a, student) unit among the sentence included in the result value of the k^{th} layer (H^{T}) out of the layers in the teacher network 20.

The control unit 160 divides a hidden state into a word unit (Representation) among the sentence included in the result value of the k^{th} layer (H^{S}) out of the layers in the student network 30. The control unit 160 trains the student network 30 such that a difference in the feature structures between the teacher network 20 and the student network 30 becomes closer through the CKA matrix. That is, as shown in FIG. 5, the control unit 160 performs the knowledge distillation of the student network 30 such that the feature structures composed of the word units are similar to each other.

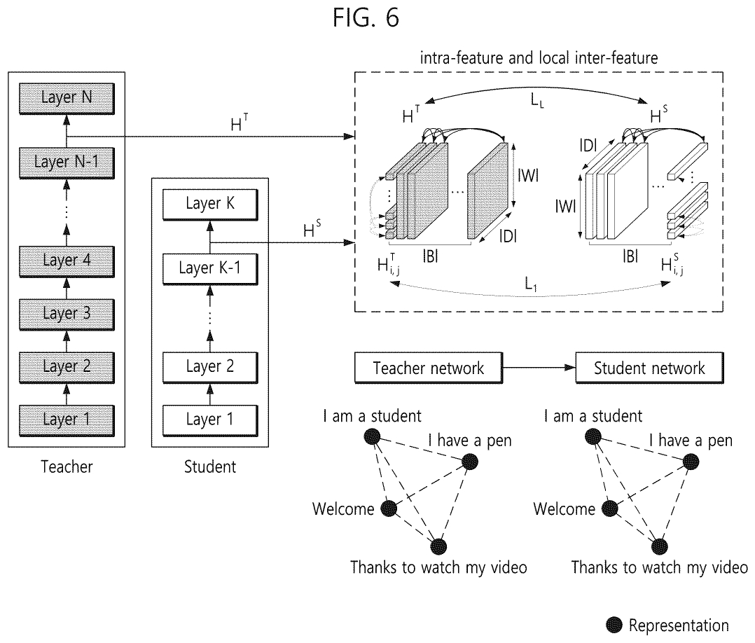

FIG. 6 is a diagram explaining a method of adjusting a local inter feature structure.

Referring to FIG. 6, the control unit 160 distinguishes hidden states of sentence units (I am a student, I have a pen, welcome, Thanks to watch my video) existing in a mini-batch within the teacher network 20. Likewise, the control unit 160 distinguishes hidden states of sentences existing in a mini-batch within the student network 30.

The control unit 160 compares the hidden states of the distinguished sentence units through the CKA matrix, followed by adjusting the student network 30 such that the values of the CKA matrix become similar to each other. That is, as shown in FIG. 6, the control unit 160 performs knowledge distillation of the student network 30 such that the feature structures composed of the sentence units (representations) are similar to each other.

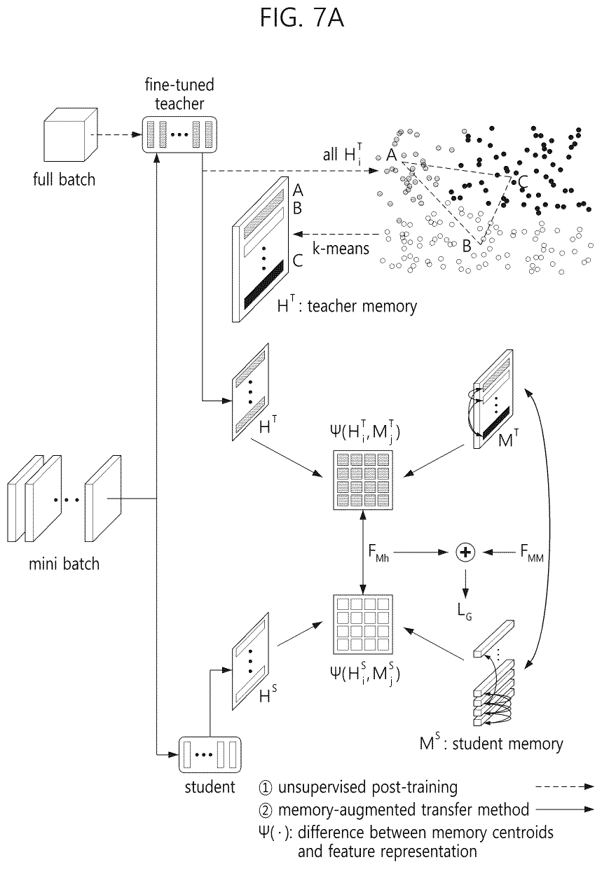

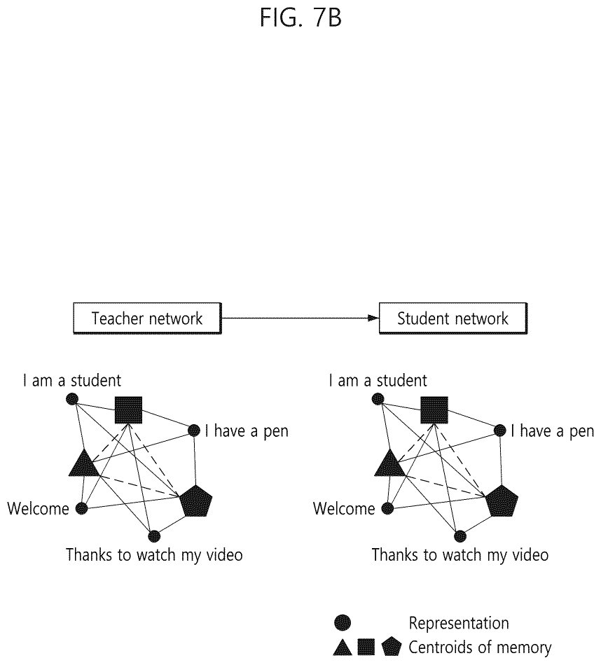

FIG. 7 is a diagram explaining a method of adjusting a global inter feature structure.

Referring to FIG. 7, the control unit 160 performs clustering between hidden states of sentences existing within mini-batches of the teacher network 20 and the student network 30. The control unit 160 controls the student network 30 to train a memory of the teacher network 20 by defining a representative value (centroid) representing the clustered hidden states. That is, the control unit 160 performs knowledge distillation of the student network (30) by defining the feature structure between the memories or between the memory and the sentence as the representative value representing the clustered hidden states, and then adjusting the feature structure in a direction that matches the representative value.

As shown in FIG. 7, the control unit 160 controls to adjust each feature structure by comparing relationships between the memory of the teacher network 20 and the hidden state obtained through the teacher network 20 with relationships between the memory of the student network 30 and the hidden state of the student network 30.

The prior arts proposed a knowledge distillation method that narrows a distance between sentences or words, but the knowledge distillation method according to an embodiment disclosure can help improve performance of the knowledge distillation by comparing and training various relationships that may occur within the sentences, and can enhance performance of the knowledge distillation through the complementary role between the finely divided processes.

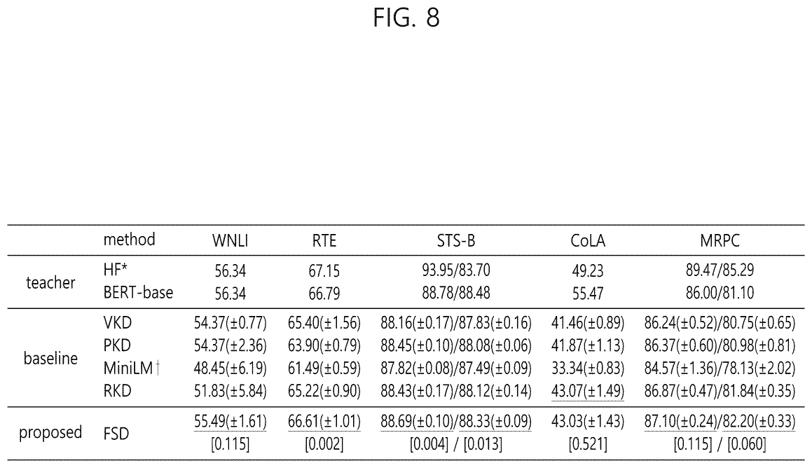

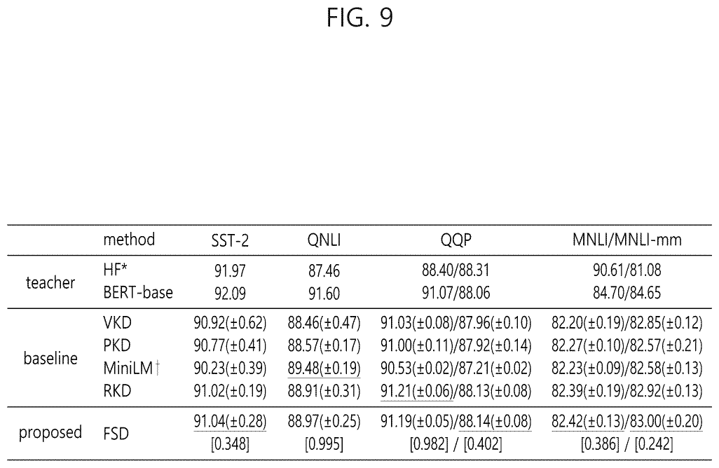

FIGS. 8 and 9 are tables for comparing performance of the knowledge distillation method according to an embodiment disclosure.

Specifically, the tables in FIGS. 8 and 9 compare performances of each artificial neural network through a GLUE benchmark. The GLUE (General Language Understanding Evaluation) benchmark is a benchmark for evaluating performance of the natural language understanding (NLU) model.

The disclosed knowledge distillation method is denoted by FSD, wherein the teacher network is a neural network based on HF* and BERT. In particular, * refers to a result value obtained from huggingface BERT. The student network used Vanilla knowledge distillation (VKD), patient knowledge distillation (PKD), relational knowledge distillation (RKD), and MiniLM⁺ as the comparison models.

Meanwhile, ⁺ refers to a model reproduced for consistency in the VKD, the PKD, and the FSD.

The Mean and Standard deviation of each evaluation matrix are numerical values obtained by the results of training each network six times. In FIG. 8, WNLI and RTE represent accuracy, STS-B represents Pearon/Spearman correlation, CoLA represents Matthew's correlation, and MRPC represents F1/accuracy.

As can be confirmed from FIG. 8, the knowledge distillation method (FSD) according to an embodiment disclosure is superior to the network to be compared in each indicator, and the CoLA is evaluated to have the numerical value which is almost close to the RKD.

In FIG. 9, SST-2, QNLI and MNLIs mean accuracy and QQP means accuracy/F1. As can be seen in FIG. 9, it can be confirmed that the knowledge distillation method (FSD) according to an embodiment disclosure is equivalent to or superior to the network to be compared in each indicator.

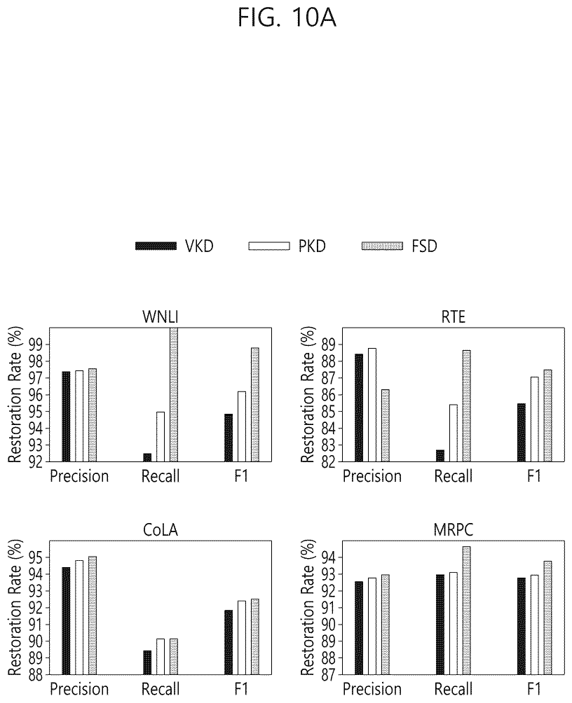

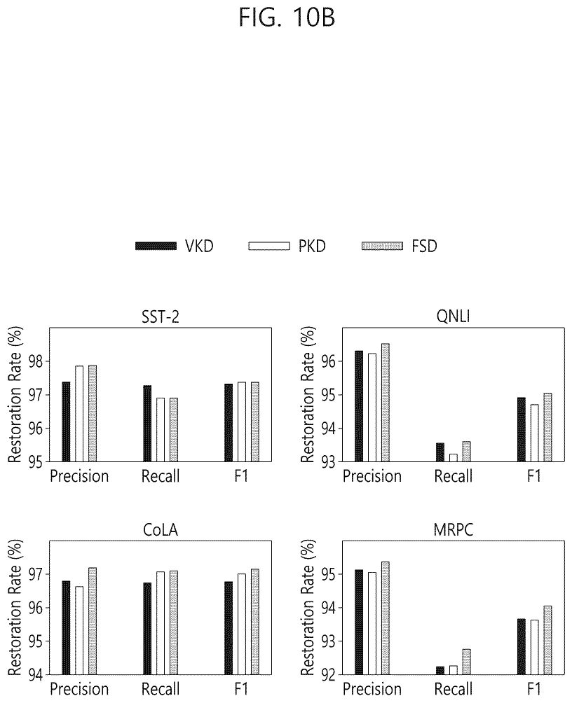

FIG. 10 is a diagram graphically representing the numerical values mentioned in FIGS. 8 and 9.

FIG. 10 also graphs the numerical values obtained from the GLUE benchmark, and shows a restoration rate in the result values (predictions) between the student network 30 and the teacher network 20.

The black bar graph represents VKD, the red bar graph represents PKD, and the blue bar graph represents the knowledge distillation method (FSD) according to an embodiment disclosure. As can be seen in the graph of FIG. 10, it can be confirmed that the FSD is equal to or superior to other networks to be compared in each indicator.

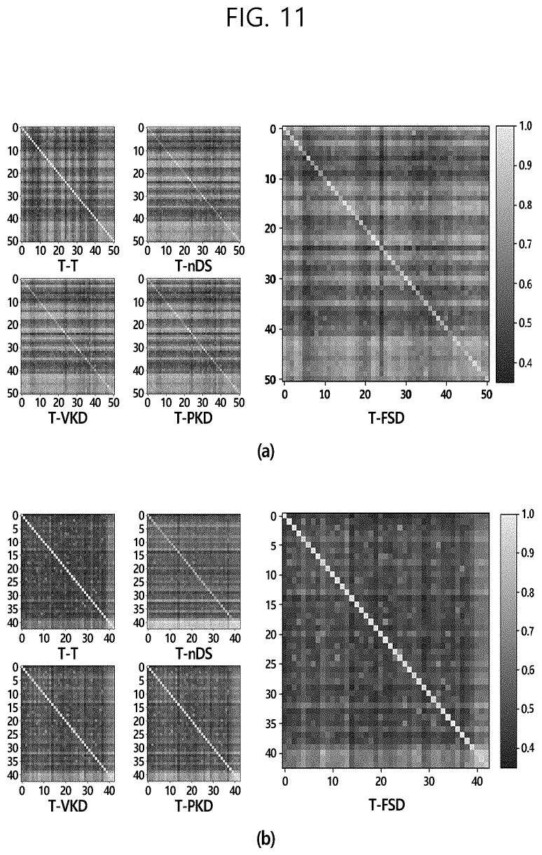

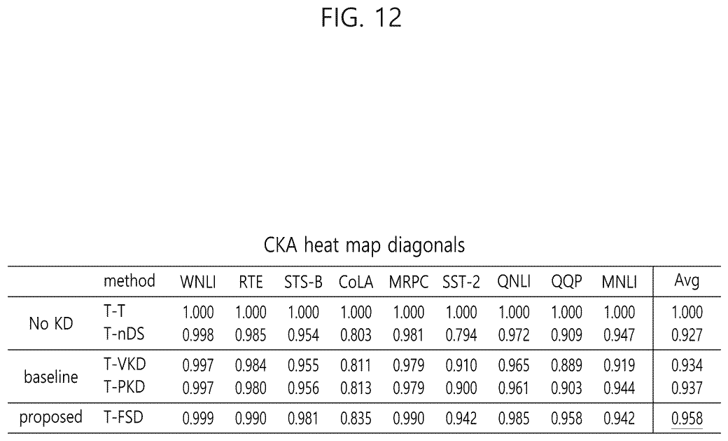

FIG. 11 is a diagram illustrating a CKA heat map, and FIG. 12 is a table quantifying the same.

The result of a CoLA data set in FIG. 11 represents a GLUE benchmark, wherein the x-axis and y-axis are indicators of a mini-batch for the same data set. Each pixel represents a CKA similarity between the teacher network and the student network. Each sample in the diagonal lines is a CKA similarity between the teacher network and the student network for the same sample, and the bar on the right of each drawing is a normalized range of the CKA similarity observed for each model. A) is the CoLA and B) is the SST-2 case.

As can be seen in FIG. 11, the heat map of the knowledge distillation method (T-FSD) according to an embodiment disclosure is very similar to the T-T heat map, and this result means that the student network 30 obtained by the knowledge distillation method according to an embodiment disclosure was trained most similarly to the teacher network 20.

The numerical values shown in each table of FIG. 12 are an average of the diagonal value for a pair of the teacher network and the student network for each network, and as can be seen in FIG. 12, the T-FSD has the highest CKA similarity value compared to the T-VKD and the T-PKD (0.958).

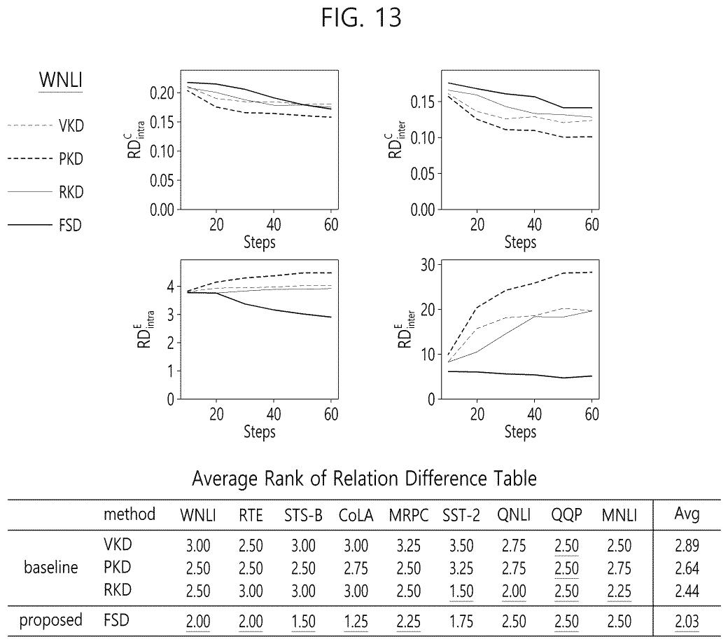

FIG. 13 is another diagram comparing each knowledge distillation method.

The table in FIG. 13 expresses a relation difference of the VKD, the PKD, the RKD, and the knowledge distillation method (FSD) according to an embodiment disclosure as the average rank, wherein the last difference value is used for ranking, which means the lower numerical, the better performance.

As can be seen from the table in FIG. 13 and the graph depicting the table, even though the knowledge distillation method (FSD) according to an embodiment disclosure shows a lower numerical value in the CKA similarity, the ranking of a Euclidean distance and a cosine similarity is superior to that of other networks.

In other words, since the knowledge distillation method and the apparatus for compressing the transformer neural network according to an embodiment disclosure allows the student network with a small capacity to operate at the same or higher level of performance than that of the teacher network with a large capacity, and makes the student network to operate even in a portable user terminal with a small memory capacity, they are also effective in reducing delay time as well as train and inference time.

### EXPLANATION OF SYMBOLS

20: Teacher network 30: Student network
100: Knowledge distillation apparatus 120: Input/output unit
140: Storage unit 160: Control unit

What is claimed is:

1. A method for training a student network comprising at least one or more of a transformer neural network by using knowledge distillation in a teacher network comprising at least one or more of the transformer neural network, the method comprising the processes of:
pre-training the teacher network using a training data and fine tuning the trained teacher network;
copying a weight parameter of a bottom layer of the teacher network to the student network; and
performing the knowledge distillation to the student network through the fine-tuned teacher network,
wherein the process of performing the knowledge distillation comprises:
extracting a feature structure from the result value of a layer of the fine-tuned teacher network;
extracting a feature structure from the result value of a layer of the student network; and
adjusting the feature structure of the extracted student network based on the feature structure of the extracted teacher network.

2. The method according to claim 1, wherein the process of performing the knowledge distillation expresses the feature structure based on a Centered Kernel Alignment (CKA) matrix.

3. The method according to claim 1, wherein the process of performing the knowledge distillation divides the result value of the layer into hidden states by word units within a sentence, and
adjusts the feature structure of the teacher network and the feature structure of the student network based on the result of comparing the hidden states divided by the word units.

4. The method according to claim 1, wherein the process of performing the knowledge distillation divides the hidden states of a sentence existing in a mini-batch, and
adjusts the feature structure of the teacher network and the feature structure of the student network based on the result of comparing the hidden states of the sentence.

5. The method according to claim 1, wherein the process of performing the knowledge distillation clusters the hidden states of each sentence existing in a mini-batch of the teacher network,
defines a representative value (centeroid) representing the clustered hidden states, and
adjusts the feature structure of a memory that operates the student network with the feature structure of a memory that operates the teacher network, based on the defined representative value.

6. The method according to claim 5, wherein the process of performing the knowledge distillation adjusts the feature structure of the teacher network and the feature structure of the student network based on the result of comparing the hidden states of each sentence and the result of comparing the feature structure of the memory.

7. An apparatus for training a student network comprising at least one or more of a transformer neural network by using knowledge distillation in a teacher network comprising at least one or more of the transformer neural network, the apparatus comprising:
a storage unit for storing a program that performs the knowledge distillation; and
a control unit comprising at least one or more processors,
wherein the control unit pre-trains the teacher network using a training data and fine tunes the trained teacher network,
copies a weight parameter of a bottom layer of the teacher network to the student network,
extracts a feature structure from the result value of a layer of the fine-tuned teacher network,
extracts a feature structure from the result value of a layer of the student network,
adjusts the feature structure of the extracted student network based on the feature structure of the extracted teacher network, and
performs the knowledge distillation on the trained student network through the trained teacher network by the adjustment of the feature structure.

8. The apparatus according to claim 7, wherein the control unit expresses the feature structure based on a Centered Kernel Alignment (CKA) matrix.

9. The apparatus according to claim 7, wherein the control unit divides the result value of the layer into hidden states by word units within a sentence, and
adjusts the feature structure of the teacher network and the feature structure of the student network based on the result of comparing the hidden states divided by the word units.

10. The apparatus according to claim 7, wherein the control unit divides the hidden states of a sentence existing in a mini-batch, and
adjusts the feature structure of the teacher network and the feature structure of the student network based on the result of comparing the hidden states of the sentence.

11. The apparatus according to claim 7, wherein the control unit clusters the hidden states of each sentence existing in a mini-batch of the teacher network,
defines a representative value (centeroid) representing the clustered hidden states, and
adjusts the feature structure of a memory that operates the student network with the feature structure of a memory that operates the teacher network, based on the defined representative value.

12. The apparatus according to claim 11, wherein the control unit adjusts the feature structure of the teacher network and the feature structure of the student network based on the result of comparing the hidden states of each sentence and the result of comparing the feature structure of the memory.
